(19) United States
(12) Patent Application Publication
(10) Pub. No.: US 2017/0207989 A1
(43) Pub. Date: Jul. 20, 2017

(54) DYNAMIC DOMAIN NAME SYSTEM DESTINATION SELECTION

(71) Applicant: Dell Software Inc., Round Rock, TX (US)

(72) Inventors: Riji Cai, Pudong New Area (CN); Zhong Chen, San Jose, CA (US); Hui Ling, Shanghai (CN)

(21) Appl. No.: 14/996,133

(22) Filed: Jan. 14, 2016

(51) Int. Cl. H04L 12/26; H04L 5/00; H04L 29/12

(52) U.S. Cl. CPC H04L 43/12; H04L 61/1511; H04L 5/0055; H04L 61/256

(57) ABSTRACT

A user device, in trying to communicate with an internet resource knowing an associated domain name, transmits a Domain Name System (DNS) request packet to a DNS server, which responds with a DNS response packet identifying multiple Internet Protocol (IP) addresses corresponding to multiple servers associated with the identified domain name. The user device then selects one of these servers and communicates with that selected server. The user device may select the server by probing properties of the servers and of the connections between the user device and each of the servers, and by then picking the server whose own properties and whose connection properties are better. The user device probes these properties by sending at least one set of probe packets to each server and receiving at least one set of probe return packets and calculating round trip time, hop distance, bandwidth, latency, packet loss rate, and other properties.

### BACKGROUND OF THE INVENTION

Field of the Invention

The present invention generally relates to optimization of network connections. More specifically, the present invention relates to selection of an optimal server for internet data transfer from a list of internet protocol (IP) addresses identified by a Domain Name System (DNS) server.

Description of the Related Art

Network-based data communications are useful for a variety of tasks, such as sending and receiving emails, browsing Internet web pages, browsing intranet private network portals, sending and receiving instant messages, telephone calls over voice-over-internet-protocol (VOIP) services, and video calls.

The Domain Name System (DNS) is a hierarchical distributed naming system for computers, services, or any resource connected to the Internet or a private network. It associates various information with domain names assigned to each of the participating entities. Most prominently, it translates domain names, which can be easily memorized by humans, to the numerical IP addresses needed for the purpose of computer services and devices worldwide. The Domain Name System is an essential component of the functionality of most Internet services because it is the Internet's primary directory service.

Typically, a user device sends a DNS request to a DNS server identifying a domain. The DNS server will respond with a DNS response that lists internet protocol (IP) addresses corresponding to that domain, or if it does not have that information, will recursively ask other DNS servers until it does. The user device then typically selects one of the IP addresses from the DNS response and makes a connection (e.g. a TCP connection) and transmits data to a selected server associated with the selected IP address and with the domain identified in the DNS request.

Typically, user devices simply pick the first IP address listed in the DNS response. The DNS server generally circles the order of the listed IP addresses using a round robin approach, thus directing a similar number of user devices to each server listed in the DNS response.

However, not all servers or network connections are equal—some servers may be physically farther away than others from the user device, and it may require more “hops” through other servers and network devices for data to get from the user device to such a faraway server. Some connections between the user device and a particular server may be limited in terms of bandwidth, may have a high latency, or may have a high packet loss rate.

Therefore, there is a need for an improved IP address selection to optimize network connections.

### SUMMARY OF THE CLAIMED INVENTION

One exemplary method for domain server communication includes receiving a domain name system (DNS) response packet over a communication network, the domain name system (DNS) response packet identifying a plurality of internet protocol (IP) addresses corresponding to a domain name. The method also includes transmitting a plurality of probe packets by transmitting a probe packet to each server of a plurality of servers, the plurality of servers corresponding to the plurality of internet protocol (IP) addresses identified in the domain name system (DNS) response packet. The method also includes receiving one or more probe return packets by receiving a probe return packet from each server of at least a subset of the plurality of servers. The method also includes calculating one or more connection parameters based on at least the receipt of the one or more probe return packets, the one or more connection parameters associated with one or more connections, the one or more connections each having an endpoint at one server of at least the subset of the plurality of servers from which a probe return packets have been received. The method also includes selecting a selected server of the plurality of servers based on at least the calculated one or more connection parameters. The method also includes communicating with the selected server.

One exemplary system for domain server communication includes a communication transceiver that is communicatively coupled to at least a plurality of servers and a domain name system (DNS) server over a communication network. The system also includes a processor coupled to a memory and to the communication transceiver. Execution of instructions stored in the memory by the processor performs a variety of system operations. The system operations include receiving a domain name system (DNS) response packet via the communication transceiver over the communication network, the domain name system (DNS) response packet identifying a plurality of internet protocol (IP) addresses corresponding to a domain name. The system operations also include transmitting a plurality of probe packets via the communication transceiver by transmitting a probe packet to each server of the plurality of servers, the plurality of servers corresponding to the plurality of internet protocol (IP) addresses identified in the domain name system (DNS) response packet. The system operations also include receiving one or more probe return packets via the communication transceiver by receiving a probe return packet from each server of at least a subset of the plurality of servers. The system operations also include calculating one or more connection parameters based on at least the receipt of the one or more probe return packets, the one or more connection parameters associated with one or more connections, the one or more connections each having an endpoint at one server of at least the subset of the plurality of servers from which a probe return packets have been received. The system operations also include selecting a selected server of the plurality of servers based on at least the calculated one or more connection parameters. The system operations also include communicating with the selected server via the communication transceiver.

One exemplary non-transitory computer-readable storage medium may have embodied thereon a program executable by a processor to perform a method for domain server communication. The exemplary program method includes receiving a domain name system (DNS) response packet over a communication network, the domain name system (DNS) response packet identifying a plurality of internet protocol (IP) addresses corresponding to a domain name. The method also includes transmitting a plurality of probe packets by transmitting a probe packet to each server of a plurality of servers, the plurality of servers corresponding to the plurality of internet protocol (IP) addresses identified in the domain name system (DNS) response packet. The method also includes receiving one or more probe return packets by receiving a probe return packet from each server of at least a subset of the plurality of servers. The method also includes calculating one or more connection parameters based on at least the receipt of the one or more probe return packets, the one or more connection parameters associated with one or more connections, the one or more connections each having an endpoint at one server of at least the subset of the plurality of servers from which a probe return packets have been received. The method also includes selecting a selected server of the plurality of servers based on at least the calculated one or more connection parameters. The method also includes communicating with the selected server.

### BRIEF DESCRIPTION OF THE FIGURES

FIG. 1 illustrates an exemplary Domain Name System (DNS) ecosystem that includes a user device, a DNS server, and a selected server of a domain server set.

FIG. 2 illustrates exemplary internet protocol (IP) addresses associated with an exemplary user device and an exemplary domain server set, including a selected server from the domain server set.

FIG. 3 illustrates exemplary Domain Name System (DNS) response information that identifies internet protocol (IP) addresses associated with an exemplary domain server set.

FIG. 4 illustrates exemplary trace-route operations performed on two servers of a domain server set.

FIG. 5 illustrates transmission of probe packets from a user device to a domain server set in an exemplary Domain Name System (DNS) ecosystem.

FIG. 6 is a table illustrating an exemplary timeline of probe packets sent between a user device and a domain server set.

FIG. 7 is a block diagram of an exemplary computing device that may be used to implement an embodiment of the present invention.

### DETAILED DESCRIPTION

A user device, in trying to communicate with an internet resource knowing an associated domain name, transmits a Domain Name System (DNS) request packet to a DNS server, which responds with a DNS response packet identifying multiple Internet Protocol (IP) addresses corresponding to multiple servers associated with the identified domain name. The user device then selects one of these servers and communicates with that selected server. The user device may select the server by probing properties of the servers and of the connections between the user device and each of the servers, and by then picking the server whose own properties and whose connection properties are better. The user device probes these properties by sending at least one set of probe packets to each server and receiving at least one set of probe return packets and calculating round trip time, hop distance, bandwidth, latency, packet loss rate, and other properties.

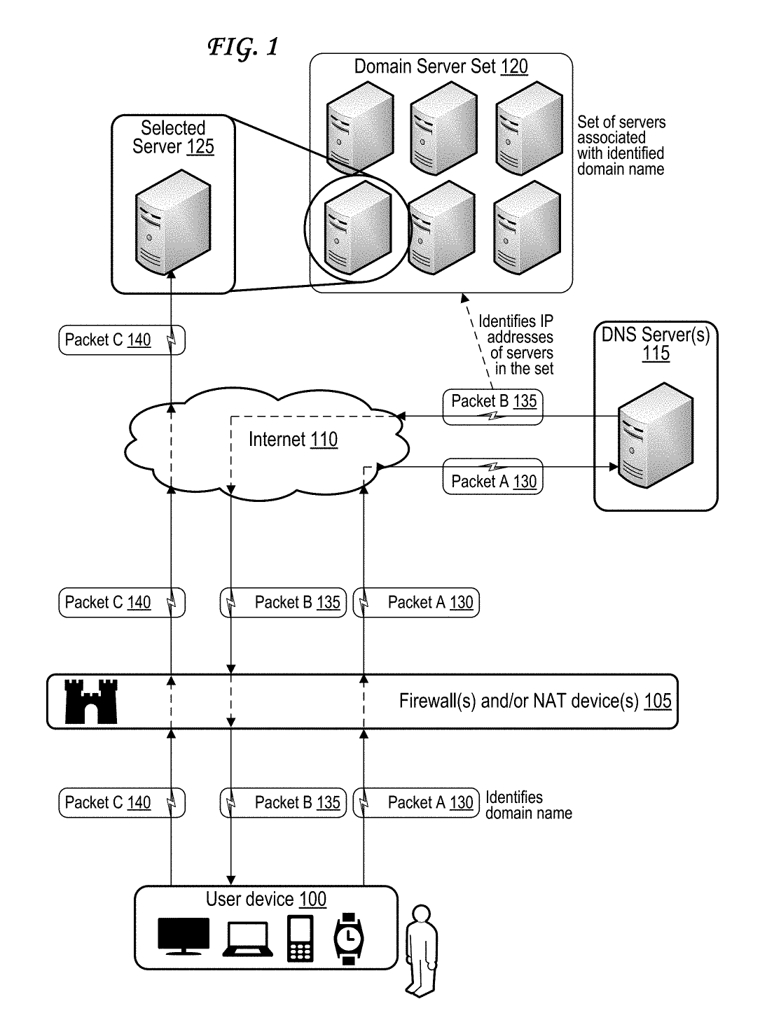

FIG. 1 illustrates an exemplary Domain Name System (DNS) ecosystem that includes a user device, a DNS server, and a selected server of a domain server set.

The user device 100 of FIG. 1 first identifies a domain name (e.g., “google.com”, “baidu.com”) associated with a set of one or more systems (i.e., the domain server set 120) that it wishes to communicate with, for example to establish Transmission Control Protocol/Internet Protocol (TCP/IP) communications. The user device 100 transmits a packet A 130 to a Domain Name System (DNS) server 115 through an internet connection 110 and optionally through one or more firewall systems (e.g. which may include software firewall systems or hardware firewall systems or some combination thereof) and/or through one or more Network Address Translation (NAT) device(s) 105, such as routers (e.g. wired, wireless, or some combination thereof).

Once the DNS server 115 receives the packet A 130, it reads the domain name identified in the packet A 130 and searches through information stored at the DNS server 115 for at least one internet protocol (IP) address of at least one server associated with that domain name. In the DNS server 115 cannot find any IP addresses matching the domain name, it may ask another DNS server for the information. If the second DNS server cannot find any IP addresses matching the domain name, it may ask yet another DNS server for the information, and so on, recursively, until one or more IP addresses corresponding to the domain name are identified or until the DNS servers 115 collectively determine that the domain name is invalid and return an error (not shown) to the user device 100.

Once the DNS server(s) 115 have identified a set of one or more IP addresses corresponding to a set of one or more servers (e.g., domain server set 120 of FIG. 1) associated with the domain name identified in packet A 130, a DNS server 115 transmits a packet B 135 back to the user device 100, again through the internet connection 110 and optionally through the firewall(s) and/or NAT device(s) 105. The packet B 135 identifies the set of one or more servers, illustrated in FIG. 1 as the domain server set 120, corresponding to the identified domain name. In many cases, such as with website hosts that have systems distributed across many physical locations for redundancy, the domain server set 120 may include servers in different physical locations around the world, sometimes with many different types of internet connections (e.g., wired Ethernet connections, wireless Wi-Fi connections, wireless cellular network connections, or some combination thereof) and often with different connection properties (e.g., different bandwidths, different latencies, different packet loss rates, or some combination thereof).

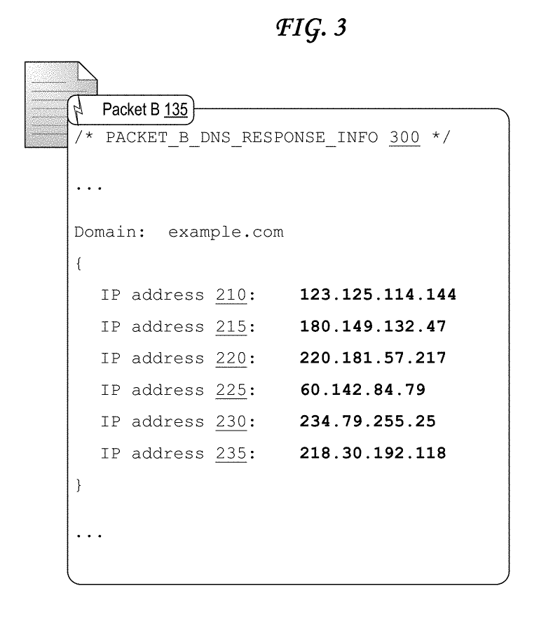

Once the user device 100 receives the packet B 135 from the DNS server(s) 115, it reads through the packet B 135 to find the listing of the IP addresses of the domain server set 120, which is simulated in a readable pseudo code format in the illustration of FIG. 3. The user device 100 then selects one of the IP addresses from the listing of the IP addresses of the domain server set 120 in the packet B 135. The selected IP address corresponds to the selected server 125.

The selected IP address associated with the selected server 125 may be selected by the user device 100 using a number of approaches. One such approach that a user device 100 can take is to simply select the first IP address listed in the DNS response (e.g., in packet B 135 of FIG. 1). For example, in the DNS response information 300 of FIG. 3, that would be the first IP address 210. This generally leads to relatively even balancing of traffic going into each server of the domain server set 120 because DNS servers 115 typically rotate (e.g., using a round-robin approach) the listing of IP addresses given to user devices each time they are transmitted to different user devices (e.g., packet B 135 in FIG. 1). However, such an approach has a significant downside in that there is no guarantee that the connection between the user device 100 and the selected server 125 will be a good connection or that another connection between the user device and another server of the domain server set 120 could have been a better connection (e.g., in terms of physical distance away, number of “hops” away, bandwidth, latency, packet loss rate, or some combination thereof). If the first address is not reachable in such an approach, the user device 100 may try the second IP address, then the third, and so forth. In a similar approach, a user device 100 may begin by selecting the last IP address listed in the DNS response (e.g., in packet B 135 of FIG. 1), or a middle IP address, or an Nth IP address for any positive integer value of N.

Another approach to selecting an IP address by the user device 100 is that the user device 100 may pick the IP address from the IP addresses listed in the DNS response (e.g., in packet B 135 of FIG. 1) that has the longest prefix match with the IP address of the user device. For example, if the IP address of the user device 100 is 123.123.123.123, and the domain server set 120 includes two servers with the IP addresses 123.123.1.1 and 124.1.1.1, then the user device 100 would choose the server with the IP address 123.123.1.1 as the selected server 125. The assumption here is that servers with matching prefixes are generally located physically closer together, meaning that the connection between the user device 100 and the selected server 125 is more likely to be better than one picked without regard to the prefixes. However, there is still no guarantee that a selected server 125 selected in this way will have the best connection with the user device 100. For example, the selected server 125 could be down or could be faulty, or the connection quality (e.g. bandwidth, packet loss, latency) could be poor due to hardware used along the connection, or the connection could be temporarily congested (e.g., if many nearby user devices 100 are using this selection process). The DNS response listing of IP addresses associated with the domain server set 120 might also be old and not reflect current network dynamics (e.g., current up-to-date IP addresses of the domain server set 120), since the DNS resolved result is often cached and the default Time To Live (TTL) value is typically 86400 seconds (24 hours) or a similarly relatively lengthy value. Servers within the domain server set 120 may also be behind one or more Network Address Translation (NAT) device(s) or one or more proxy server(s) or some combination thereof, which means that the true IP address of the selected server 125 is masked/hidden/private and might not be close to the user device 100 after all.

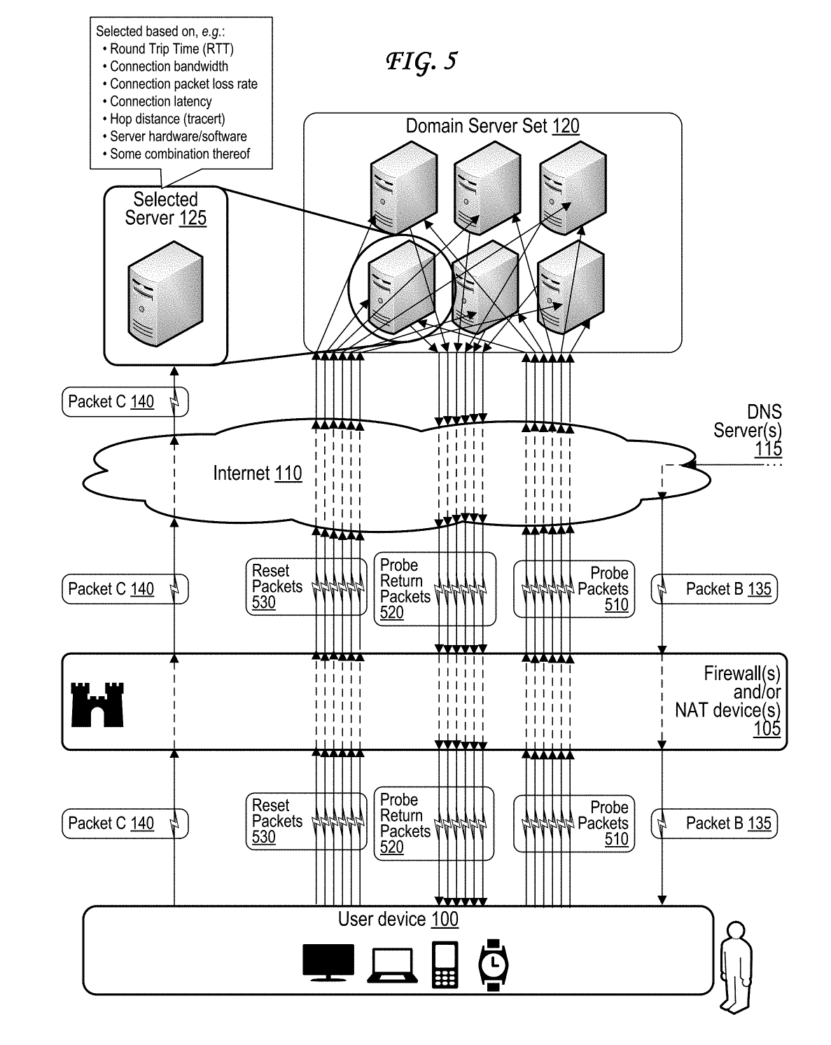

Yet another approach to selecting an IP address by the user device 100 involves sending one or more probe packets from the user device 100 to each server of the domain server set 120 as illustrated in FIG. 5 and as described further in reference to FIG. 5. This approach may require a little more time than the two previously-mentioned approaches, since it requires brief probing network exchanges (e.g., to determine a round trip time, which takes on average approximately 150 ms in a typical network) rather than making the decision purely locally at the user device 100. The end result, however, is that the user device 100 is able to pick a selected server 125 such that the connection between the user device 100 and the selected server 125 is measurably equal to or better than the connections between the user device 100 and other servers in the domain server set 120 (besides the selected server 125), at least at the time of the brief probing network exchanges.

Once the user device 100 selects the selected IP address corresponding to the selected server 125, the user device 100 then transmits a packet C 140 to the selected server 125. The packet C 140 may include information that the user device 100 originally intended to get to a server associated with the domain name, and may for example include a Hypertext Transfer Protocol (HTTP) request, a File Transfer Protocol (FTP) request, a Simple Mail Transfer Protocol (SMTP) request, a secure variant of any of these (e.g. using Secure Sockets Layer or Transport Layer Security protocols), or some combination thereof.

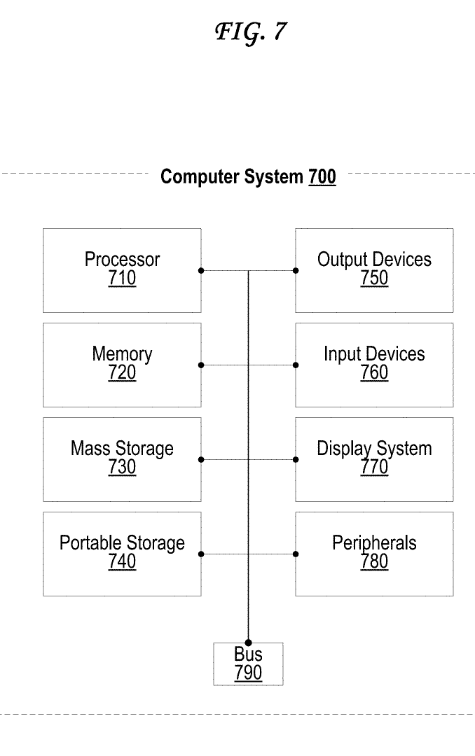

Each of the user device 100, the DNS server(s) 115, and the domain server set 120 may include at least one variant of computer system 700 identified in FIG. 7 or its description, or may include at least a subset of the hardware components and software elements identified in FIG. 7 or its description. Each of the user device 100, the DNS server(s) 115, and the domain server set 120 may include one or more memory and/or data storage module(s) (e.g., which may include any kind of memory 720, mass storage 730, portable storage 740, or some combination thereof), one or more processor(s) (e.g., processor 710), one or more input mechanism(s) (e.g. one or more input devices 760), one or more display screen(s) (e.g., such as display system 770), or some combination thereof. Each of the user device 100, the DNS server(s) 115, and the domain server set 120 may include one or more such systems, which may be privately networked or distributed or some combination thereof, and which may include physical systems or virtual systems or some combination thereof.

It should be understood that the network connection labeled “internet 110” in FIG. 1 may alternately refer to one or more private networks, which may include local area networks (LAN), wireless local area networks (WLAN), municipal area networks (MAN), or wide area networks (WAN).

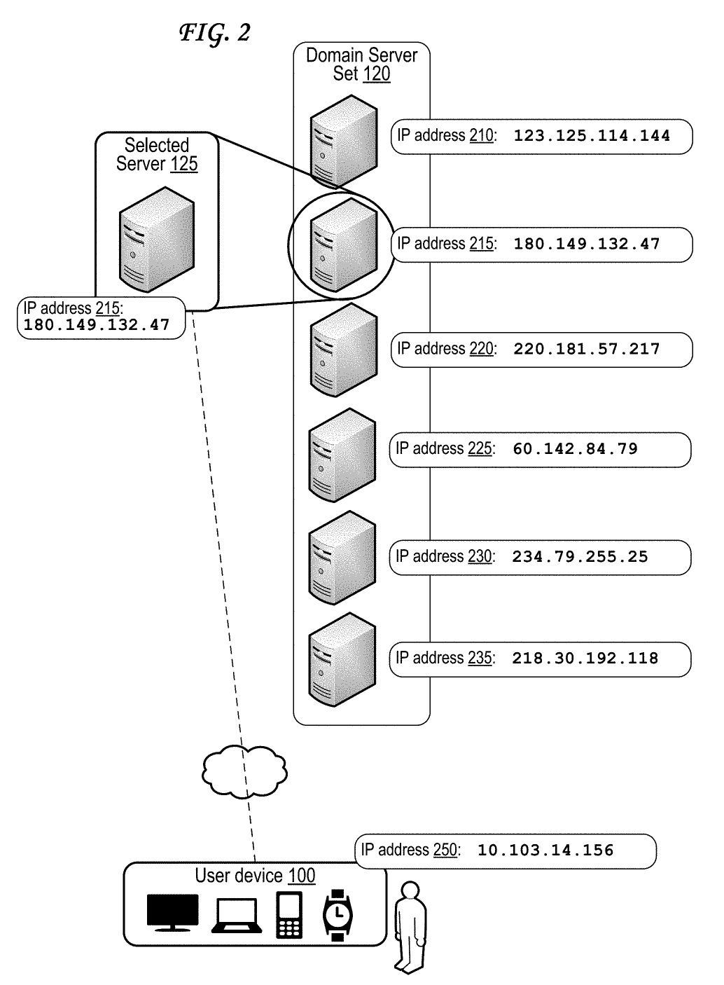

FIG. 2 illustrates exemplary internet protocol (IP) addresses associated with an exemplary user device and an exemplary domain server set, including a selected server from the domain server set.

In particular, the domain server set 120 illustrated in FIG. 2 includes six servers. The first server of the domain server set 120 has an IP address 210 of “123.125.114.144.” The second server of the domain server set 120 has an IP address 215 of “180.149.132.47.” The third server of the domain server set 120 has an IP address 220 of “220.181.57.217.” The fourth server of the domain server set 120 has an IP address 225 of “60.142.84.79.” The fifth server of the domain server set 120 has an IP address 230 of “234.79.255.25.” The sixth server of the domain server set 120 has an IP address 235 of “218.30.192.118.”

The selected server 125, as illustrated in FIG. 2, is the second server of the domain server set 120, which has an IP address 215 of “180.149.132.47.” The user device 100 illustrated in FIG. 2 has an IP address 250 that is identified as “10.103.14.156.”

FIG. 3 illustrates exemplary Domain Name System (DNS) response information that identifies internet protocol (IP) addresses associated with an exemplary domain server set.

In particular, the packet B 135 may include data exemplified by the PACKET_B_DNS_RESPONSE_INFO 300 of FIG. 3, which lists and identifies the IP address 210, the IP address 215, the IP address 220, the IP address 225, the IP address 230, and the IP address 235 as identified in FIG. 2.

The user device 100 may use the DNS response information 300 of FIG. 3 to select an IP address corresponding to the selected server 125 of the domain server set 120 as described in relation to FIG. 1 or FIG. 5.

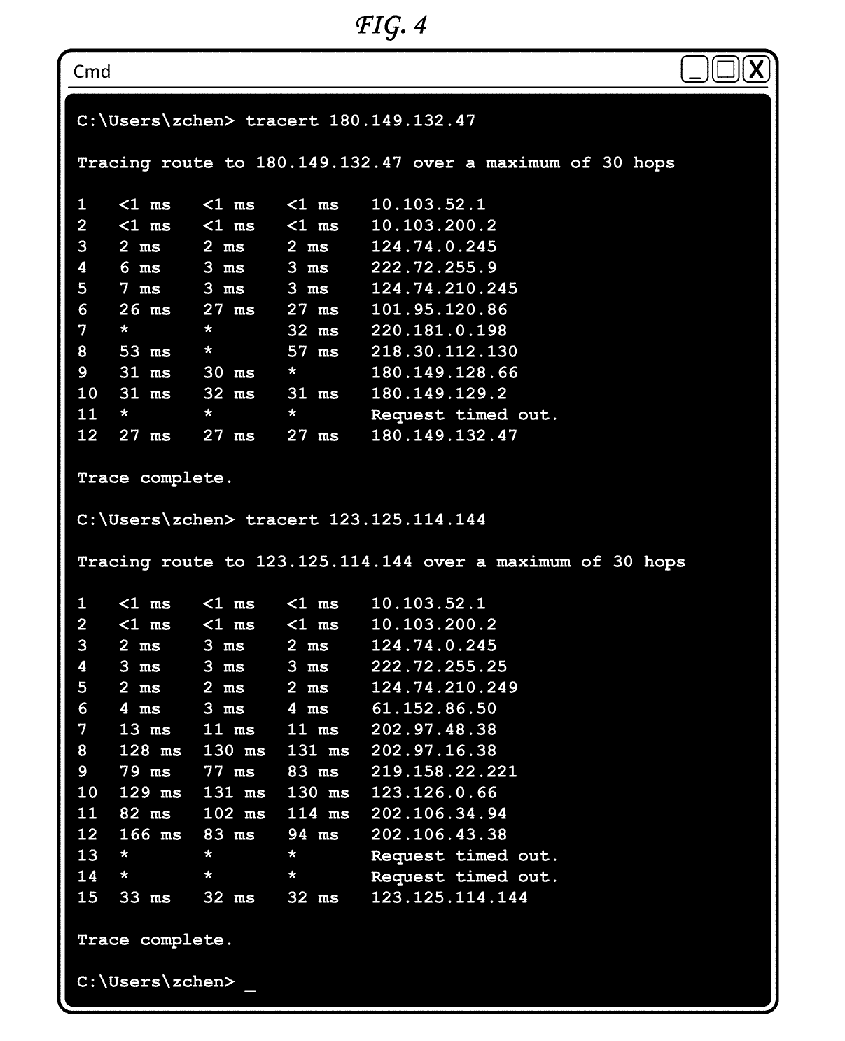

FIG. 4 illustrates exemplary trace-route operations performed on two servers of a domain server set. In particular, a trace route operation “tracert” is illustrated in FIG. 4 for the IP address 215 (“180.149.132.47”) and for the IP address 210 (“123.125.114.144”).

The traceroute operation illustrated in FIG. 4 for the IP address 215 (“180.149.132.47”) has a 12 hop distance, while the traceroute operation for the IP address 210 (“123.125.114.144”) has a 15 hop distance. Thus, the IP address 210 (“123.125.114.144”) is farther away than the IP address 210 (“123.125.114.144”), at least in terms of hop distance.

FIG. 5 illustrates transmission of probe packets from a user device to a domain server set in an exemplary Domain Name System (DNS) ecosystem. The probe packets serve a similar function to a ping command and can be used to determine properties of the connections between the user device 100 and each server of the domain server set 120.

As illustrated in FIG. 5, once the user device 100 receives the packet B 135 with the DNS response listing the IP addresses of the servers in the domain server set 120 (e.g. see FIG. 2 and FIG. 3), the user device 100 transmits a set of probe packets 510 such that a probe packet is sent to every server in the domain server set 120, in particular to the port that the user device 100 wishes to connect to. The probe packets 510 may be SYN packets using a TCP protocol (e.g., packets with a SYN flag set to 1).

Once each server of the domain server set 120 receives its probe packet of the probe packets 510, the server transmits a probe return packet back to the user device 100. The user device 100 will thus receive a set of one or more probe return packets 520 from at least a subset of the servers of the domain server set 120. The user device 100 might not receive a probe return packet from all of the servers in the domain server set 120, for example if one of the servers is down or experiencing errors, or if the packet is lost due to a high packet loss rate of an unreliable (e.g., congested) connection, or if the connection to the server is overly congested, faulty, or severed. The probe return packets 520 may be ACK packets using a TCP protocol.

The user device 100 may optionally send a set of reset packets 530 to the domain server set 120, so that each server of the domain server set 120 receives a reset packet from the user device 100. The reset packets 530 may be used to reset the connections between the user device 100 and each server of the domain server set 120. The reset packets 530 may be RST packets using a TCP protocol. Note that the RST packets 530 are only needed if the probe packets 510 use TCP probing. If the probe packets 510 instead use ICMP probing or UDP probing, there is no need for the RST packets 530.

The user device 100 may measure how much time has elapsed between the transmission of each of the probe packets 510 and receipt of each of the corresponding probe return packets 520. From this, the user device 100 may determine a round trip time (RTT) for each connection between the user device 100 and each server of the domain server set 120. The user device 100 may also optionally use the probe packets 510 and probe return packets 520 to determine a hop distance between the user device 100 and each server of the domain server set 120 using a traceroute process as illustrated in FIG. 4. The user device 100 may also optionally use the probe packets 510 and probe return packets 520 to determine other connection properties (e.g. connection bandwidth, connection latency, connection packet loss rate) of the connections between the user device 100 and each server of the domain server set 120. The user device 100 may also optionally use the probe packets 510 to request information (to be sent back in the probe return packets 520) about the hardware components present (e.g., processor speed, processor type, memory amount, memory type, storage amount, storage type, BIOS, firewall hardware, NAT hardware, wired and wireless connection hardware) in each server of the domain server set 120 and the software installed (e.g., operating systems, compilers, interpreters, virtual machine software, firewall software, NAT software, hardware driver software, browser software, email client software, or other internet-enabled software) on each server of the domain server set 120.

In some cases (not pictured), the process described above, at least including the transmission of a set of probe packets by the user device 100 and the receipt of a set of probe return packets 520, may be repeated a predetermined number of times, for example to test reliability of servers over time, to get a more accurate average round trip time (average RTT) or hop distance value for each server by averaging consecutive round trip times (RTTs) or hop distances for each server of the domain server set 120, or to get a better idea of packet loss rate or bandwidth in each connection.

Once the user device 100 receives the probe return packets 520 from at least a subset of the domain server set 120, it may use the information it has gathered to make its decision about which server it will select from the domain server set 120 to be the selected server 125. It may, for example, pick the server with the shortest round trip time (RTT), the server that is the shortest hop distance away, the server whose connection has the best bandwidth, the server whose connection has the best latency, the server whose connection has the best packet loss rate, the server with the fastest/best hardware setup, the server with the fastest/best software setup, or some combination thereof (e.g., a heuristic may be calculated that takes several of these factors into account—in which some factors may optionally have more weight/importance than others).

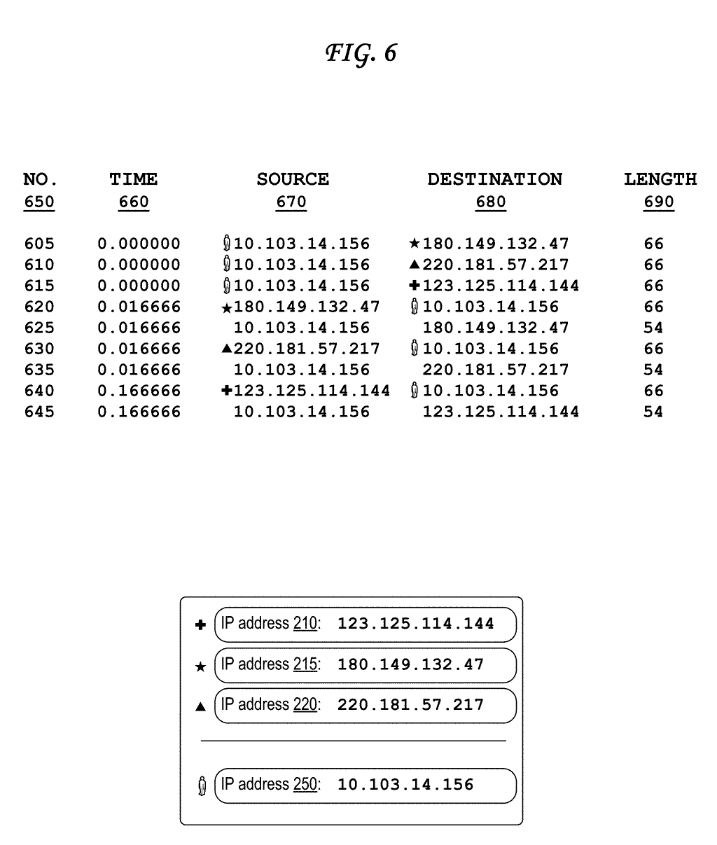

FIG. 6 is a table illustrating an exemplary timeline of probe packets sent between a user device and a domain server set. The domain server set 120 of FIG. 6 includes only three servers, namely a server corresponding to the IP address 215 (marked by a star icon), a server corresponding to the IP address 220 (marked by a triangle icon), and a server corresponding to the IP address 210 (marked by a cross icon).

The table of FIG. 6 includes a number column 650 identifying each transmission or receipt of a packet with an identifying numerical value, a time column 660 measuring time elapsed from a start point, a source column 670 identifying a source of a packet identified by a particular number in the number column 650, a destination column 680 identifying a destination of a packet identified by a particular number in the number column 650, and a length column 690 identifying a length of a packet identified by a particular number in the number column 650.

The first three packets, identified by numbers 605, 610, and 615, are probe packets sent from the IP address 250 of the user device 100 (marked by a humanoid icon). Probe packet 605 is sent to IP address 215 (marked by a star icon). Probe packet 610 is sent to IP address 220 (marked by a triangle icon). Probe packet 615 is sent to IP address 210 (marked by a cross icon).

The third, fifth, and seventh packets, identified by numbers 620, 630, and 640, are probe return packets sent back to the user device 100 (marked by a humanoid icon). Probe packet 620 is sent from IP address 215 (marked by a star icon). Probe packet 630 is sent to IP address 220 (marked by a triangle icon). Probe packet 640 is sent to IP address 210 (marked by a cross icon).

The round trip time (RTT) of the connection between the user device 100 and the server corresponding to the IP address 215 (marked by a star icon) is 0.016666 milliseconds. The round trip time (RTT) of the connection between the user device 100 and the server corresponding to the IP address 220 (marked by a triangle icon) is also 0.016666 milliseconds. The round trip time (RTT) of the connection between the user device 100 and the server corresponding to the IP address 210 (marked by a cross icon), however, is 0.166666 milliseconds.

Therefore, if the user device 100 is basing its decision of selected server 125 purely on round trip time (RTT), it should pick either the server corresponding to the IP address 215 (marked by a star icon) or the server corresponding to the IP address 220 (marked by a triangle icon), which have an equally short round trip time (RTT) of 0.016666 milliseconds, rather than the server corresponding to the IP address 210 (marked by a cross icon), which has a significantly longer round trip time (RTT) of 0.166666 milliseconds. Note that while FIG. 6 illustrates the server corresponding to IP address 215 (marked by the star icon) and the server corresponding to the IP address 220 (marked by the triangle icon) as having the same RTT, this may simply be a function of the time-measurement resolution of the user device 100. For example, the time-measurement resolution used by the user device 100 appears to be 1 tick, which is equivalent to 1/60 second. It thus may be unable to differentiate a time difference between any probe return packets 520 coming back after one tick but before a following tick. The user device 100, may, however, be configured to use a higher time-measurement resolution, such as 1/120 second, or 1/1000 second, or 1/6000 second, or 1/120000 second, or something between these, or an even finer time-measurement resolution.

The fifth packet 625, the seventh packet 635, and the ninth packet 645 all represent a second transmission from the user device 100 to each of the server corresponding to the IP address 215, the server corresponding to the IP address 220, and the server corresponding to the IP address 210, respectively. These may represent be the reset packets 530. Alternately, these could represent a second set of probe packets 510. These have been left unmarked to visually bring more attention to the initial probe packets 510 and probe return packets 520 of FIG. 6.

FIG. 7 illustrates an exemplary computing system 700 that may be used to implement an embodiment of the present invention. For example, any of the computer systems or computerized devices described herein may, in at least some cases, be a computing system 700. The computing system 700 of FIG. 7 includes one or more processors 710 and memory 710. Main memory 710 stores, in part, instructions and data for execution by processor 710. Main memory 710 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 710 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 770 receives textual and graphical information, and processes the information for output to the display device. The display system 770 may include multiple-touch touch screen input capabilities, such as capacitive touch detection, resistive touch detection, surface acoustic wave touch detection, or infrared touch detection. Such touch screen input capabilities may or may not allow for variable pressure or force detection.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 700 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 700 may be part of a multi-computer system that uses multiple computer systems 700 (e.g., for one or more specific tasks or purposes). For example, the multi-computer system may include multiple computer systems 400 communicatively coupled together via one or more private networks (e.g., at least one LAN, WLAN, MAN, or WAN), or may include multiple computer systems 700 communicatively coupled together via the internet (e.g., a “distributed” system), or some combination thereof.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for domain server communication, the method comprising:
receiving a domain name system (DNS) response packet over a communication network, the domain name system (DNS) response packet identifying a plurality of internet protocol (IP) addresses corresponding to a domain name;
transmitting a plurality of probe packets by transmitting a probe packet to each server of a plurality of servers, the plurality of servers corresponding to the plurality of internet protocol (IP) addresses identified in the domain name system (DNS) response packet;
receiving one or more probe return packets by receiving a probe return packet from each server of at least a subset of the plurality of servers;
calculating one or more connection parameters based on at least the receipt of the one or more probe return packets, the one or more connection parameters associated with one or more connections, the one or more connections each having an endpoint at one server of at least the subset of the plurality of servers from which a probe return packets have been received;
selecting a selected server of the plurality of servers based on at least the calculated one or more connection parameters; and
communicating with the selected server.

2. The method of claim 1, wherein calculating the one or more connection parameters includes calculating a round trip time (RTT) from a transmission time of a first probe packet to a receipt time of a first probe return packet.

3. The method of claim 1, wherein calculating the one or more connection parameters includes calculating a hop distance to a first server.

4. The method of claim 1, wherein calculating the one or more connection parameters includes calculating one of a connection bandwidth, a connection latency, a connection packet drop rate, or some combination thereof.

5. The method of claim 1, wherein calculating the one or more connection parameters includes identifying one or more hardware components of a first server or a first connection or some combination thereof.

6. The method of claim 1, wherein calculating the one or more connection parameters includes identifying one or more software elements executed by a first server.

7. The method of claim 1, further comprising transmitting a domain name system (DNS) request to a domain name system (DNS) server, the domain name system (DNS) request identifying the domain name corresponding to the plurality of internet protocol (IP) addresses.

8. The method of claim 1, further comprising transmitting a reset packet to at least the subset of servers following receipt of the one or more probe return packets.

9. The method of claim 8, wherein the probe packets are SYN packets, the probe return packets are ACK packets, and the reset packets are RST packets.

10. A system for domain server communication, the system comprising:
a communication transceiver, the communication transceiver communicatively coupled to at least a plurality of servers and a domain name system (DNS) server over a communication network; and
a processor coupled to a memory and to the communication transceiver, wherein execution of instructions stored in the memory by the processor:
receives a domain name system (DNS) response packet via the communication transceiver over the communication network, the domain name system (DNS) response packet identifying a plurality of internet protocol (IP) addresses corresponding to a domain name,
transmits a plurality of probe packets via the communication transceiver by transmitting a probe packet to each server of the plurality of servers, the plurality of servers corresponding to the plurality of internet protocol (IP) addresses identified in the domain name system (DNS) response packet,
receives one or more probe return packets via the communication transceiver by receiving a probe return packet from each server of at least a subset of the plurality of servers,
calculates one or more connection parameters based on at least the receipt of the one or more probe return packets, the one or more connection parameters associated with one or more connections, the one or more connections each having an endpoint at one server of at least the subset of the plurality of servers from which a probe return packets have been received,
selects a selected server of the plurality of servers based on at least the calculated one or more connection parameters, and
communicates with the selected server via the communication transceiver.

11. The system of claim 10, wherein calculating the one or more connection parameters via execution of the instructions by the processor includes calculating a round trip time (RTT) from a transmission time of a first probe packet to a receipt time of a first probe return packet.

12. The system of claim 10, wherein calculating the one or more connection parameters via execution of the instructions by the processor includes calculating a hop distance to a first server.

13. The system of claim 10, wherein calculating the one or more connection parameters via execution of the instructions by the processor includes calculating one of a connection bandwidth, a connection latency, a connection packet drop rate, or some combination thereof.

14. The system of claim 10, wherein calculating the one or more connection parameters via execution of the instructions by the processor includes identifying one or more hardware components of a first server or a first connection or some combination thereof.

15. The system of claim 10, wherein calculating the one or more connection parameters via execution of the instructions by the processor includes identifying one or more software elements executed by a first server.

16. The system of claim 10, wherein execution of the instruction by the processor further transmits a domain name system (DNS) request to a domain name system (DNS) server, the domain name system (DNS) request identifying the domain name corresponding to the plurality of internet protocol (IP) addresses.

17. The system of claim 10, wherein execution of the instruction by the processor further transmits a reset packet to at least the subset of servers following receipt of the one or more probe return packets.

18. The system of claim 17, wherein the probe packets are SYN packets, the probe return packets are ACK packets, and the reset packets are RST packets.

19. The system of claim 10, further comprising one or more additional devices communicatively coupled to the communication transceiver along a connection to the communication network, the one or more additional devices including one or more firewall devices, one or more Network Address Translation (NAT) devices, or some combination thereof.

20. A non-transitory computer-readable storage medium, having embodied thereon a program executable by a processor to perform a method for domain server communication, the method comprising:
receiving a domain name system (DNS) response packet over a communication network, the domain name system (DNS) response packet identifying a plurality of internet protocol (IP) addresses corresponding to a domain name;
transmitting a plurality of probe packets by transmitting a probe packet to each server of a plurality of servers, the plurality of servers corresponding to the plurality of internet protocol (IP) addresses identified in the domain name system (DNS) response packet;
receiving one or more probe return packets by receiving a probe return packet from each server of at least a subset of the plurality of servers;
calculating one or more connection parameters based on at least the receipt of the one or more probe return packets, the one or more connection parameters associated with one or more connections, the one or more connections each having an endpoint at one server of at least the subset of the plurality of servers from which a probe return packets have been received;
selecting a selected server of the plurality of servers based on at least the calculated one or more connection parameters; and
communicating with the selected server.
